(19) United States
(12) Patent Application Publication
(10) Pub. No.: US 2017/0089474 A1
(43) Pub. Date: Mar. 30, 2017

(54) CENTRAL WATER PURIFIER CONTROL VALVE

(71) Applicant: Xiamen Runner Industrial Corporation, Xiamen (CN)

(72) Inventors: FENG-SHUN ZHAN, Xiamen (CN); MING-HUA JIANG, Xiamen (CN)

(21) Appl. No.: 15/269,948

(22) Filed: Sep. 19, 2016

(30) Foreign Application Priority Data
Sep. 25, 2015 (CN) 201520750185.8

(51) Int. Cl. F16K 11/074; F16K 27/04

(52) U.S. Cl. CPC F16K 11/0743; F16K 27/04

(57) ABSTRACT

A central water purifier control valve comprises: a valve body, a valve core component, and a lock tight cover. The valve core component is disposed vertically in the valve body, including; a cover shape valve core sleeve, having a lower opening; a valve core bottom seat plate, fixed at the lower opening of the cover shape valve core sleeve; a fix ceramic plate, disposed between the cover shape valve core sleeve and the valve core bottom seat plate; a movable ceramic plate, disposed between the cover shape valve core sleeve and the valve core bottom seat plate; and a rotation axis, disposed between an inner wall of the cover shape valve core sleeve and the valve core bottom seat plate, used to drive the movable ceramic plate into rotation, while penetrating through the cover shape valve core sleeve.

### BACKGROUND OF THE INVENTION

Field of the Invention

The present invention relates to a water purifier control valve, and in particular to a central water purifier control valve.

The Prior Arts

Presently, both the industrial and household water treatment systems make use of multiple valve to perform control. In recent years, control valves having flat seal structure are utilized extensively in water treatment. For the filter system control valve using flat seal structure, the pressure between the fix plate and the movable plate is large enough to ensure tight seal. However, in this way, in switching water route, the rotation torque tends to be too strong to be controlled effectively.

Therefore, presently, the design and performance of the water control valve is not quite satisfactory, and it leaves much room for improvement.

### SUMMARY OF THE INVENTION

In view of the problems and drawbacks of the prior art, the present invention provides a central water purifier control valve, that is simple in design and compact in structure, to ensure that in switching water route, the rotation torque is constant and can be controlled effectively.

The present invention provides a central water purifier control valve, comprising: a valve body, a valve core component, and a lock tight cover. The valve core component is disposed vertically in the valve body, including; a cover shape valve core sleeve, having a lower opening; a valve core bottom seat plate, fixed at the lower opening of the cover shape valve core sleeve; a fix ceramic plate, disposed between an inner wall of the cover shape valve core sleeve and the valve core bottom seat plate; a movable ceramic plate, disposed between an inner wall of the cover shape valve core sleeve and the valve core bottom seat plate; and a rotation axis, disposed between an inner wall of the cover shape valve core sleeve and the valve core bottom seat plate, used to drive the movable ceramic plate into rotation, while penetrating through the cover shape valve core sleeve. The lock tight cover is used to press the valve core component tightly in the valve body, to press it onto the cover shape valve core sleeve.

In an aspect of the present invention, the central water purifier control valve further includes: an slot, disposed on an upper surface of the movable ceramic plate, used to position a lower end head of the rotation axis; a first center sink hole, disposed at a center portion of a lower surface of the movable ceramic plate; a first sink hole, a second sink hole, and a third sink hole, disposed not in communication with each other, and disposed around the first center sink hole, on a lower surface of the movable ceramic plate; a separation indent hole slot, disposed between the second sink hole and the third sink hole, and in communication with the first center sink hole; and eight through holes, disposed on the fix ceramic plate, with equal spacing to each other, such that when the fix ceramic plate is attached to the movable ceramic plate, the first sink hole covers a cross section area of the three through holes, and the second sink hole and the third sink hole cover the cross section areas of the other two through holes respectively, while the separation indent hole slot covers the cross section area of the through hole.

In another aspect of the present invention, the central water purifier control valve further includes: five through hole positions, disposed on the valve core bottom seat plate, corresponding to five of eight through holes on the fix ceramic plate, wherein three of the five through hole positions are blind hole positions, while the three blind hole positions are spaced apart by two of the five through hole positions.

In yet another aspect of the present invention, the central water purifier control valve further includes: a water input port, a water output port, and a waste water port, disposed at a middle section of the valve body, and are connected to a filter core at a bottom portion of the valve body; a water input channel, disposed at a lower portion of the valve core bottom seat plate, and in communication with the water input port; a water output channel, disposed at the lower portion of the valve core bottom seat plate, and in communication with the water output port; a waste water channel, disposed at the lower portion of the valve core bottom seat plate, and in communication with the waste water port; a central channel, disposed at the lower portion of the valve core bottom seat plate, and in communication with a filter core water output port on an upper portion of the filter core; and two water passage channels, disposed at the lower portion of the valve core bottom seat plate, and in communication with a filter core water input port on the lower portion of the filter core.

In a further aspect of the present invention, the central water purifier control valve further includes: three positioning slots, disposed beside the water input channel and the water output channel, to act in cooperation with three positioning pins at a lower surface of the valve core bottom seat plate.

In another aspect of the present invention, the water input channel, the water output channel, the waste water channel, the two water passage channels, and the three positioning slots correspond to the eight through hole positions on the valve core bottom seat plate.

The operation principle of the central water purifier control valve is described as follows: through disposing the valve core bottom seat plate at the lower opening of the cover shape valve core sleeve, the space between the inner wall of the cover shape valve core sleeve and the valve core bottom seat plate is fixed, so that the rotation axis is able to drive the movable ceramic plate to rotate freely relative to the fix ceramic plate. Therefore, regardless of the magnitude of the lock tight force exerted through the lock tight cover, the pressing force between the flat-seal movable ceramic plate and fix ceramic plate can be kept constant, to ensure that, in switching water routes, the rotation torque remains constant and can be controlled effectively.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is a top view of a central water purifier control valve according to an embodiment of the invention;

FIG. 2 is an exploded view of a central water purifier control valve according to an embodiment of the invention;

FIG. 3 is a cross section view of a central water purifier control valve according to an embodiment of the invention;

FIG. 4 is a cross section view of a valve core component according to an embodiment of the invention;

FIG. 5 is an exploded view of a valve core component according to an embodiment of the invention;

FIG. 6 is a top view of a movable ceramic plate according to an embodiment of the invention;

FIG. 7 is a cross section view along the A-A line of FIG. 6 according to an embodiment of the invention;

FIG. 8 is a cross section view along the B-B line of FIG. 6 according to an embodiment of the invention;

FIG. 9 is a schematic diagram of a movable ceramic plate according to an embodiment of the invention;

FIG. 10 is a top view of a fix ceramic plate according to an embodiment of the invention;

FIG. 11 is a schematic diagram of a valve core bottom seat plate according to an embodiment of the invention;

FIGS. 12a, 12b, 12c are schematic diagrams showing water purifying routes according to an embodiment of the invention;

FIGS. 13a, 13b, 13c are schematic diagrams showing filter core forward flushing water routes according to an embodiment of the invention; and

FIGS. 14a, 14b, 14c are schematic diagrams showing filter core reverse flushing water routes according to an embodiment of the invention.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

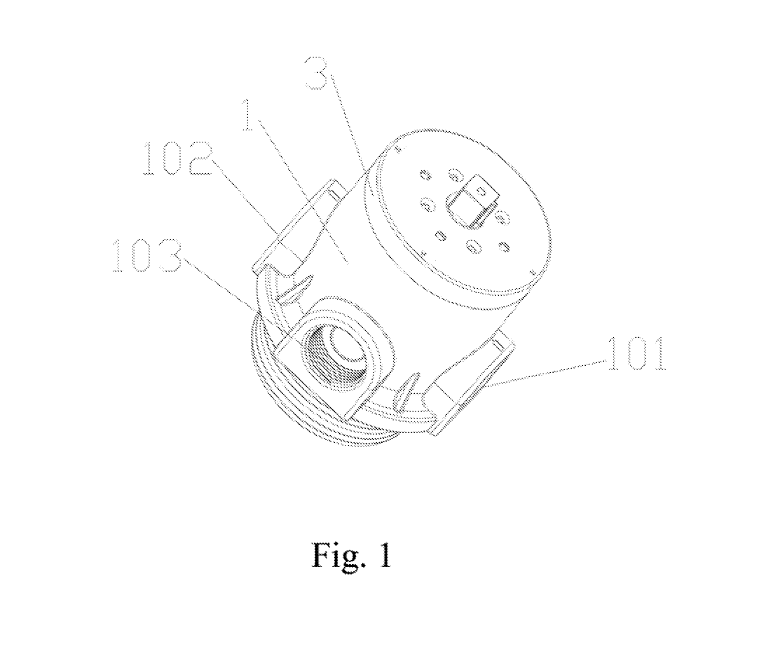

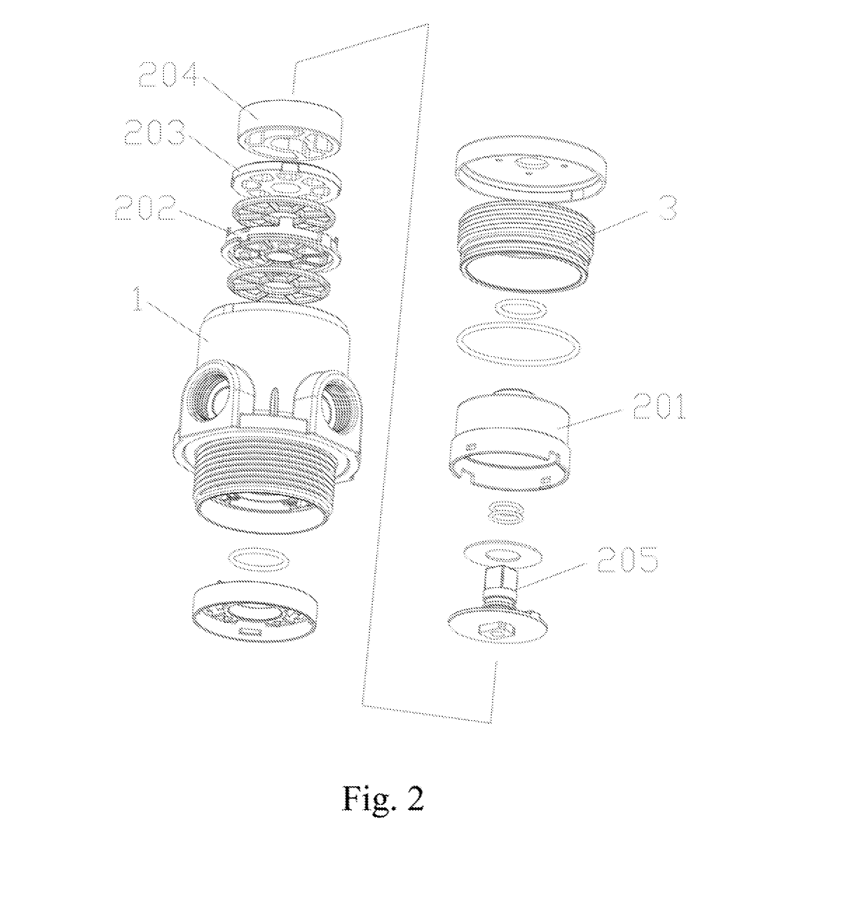

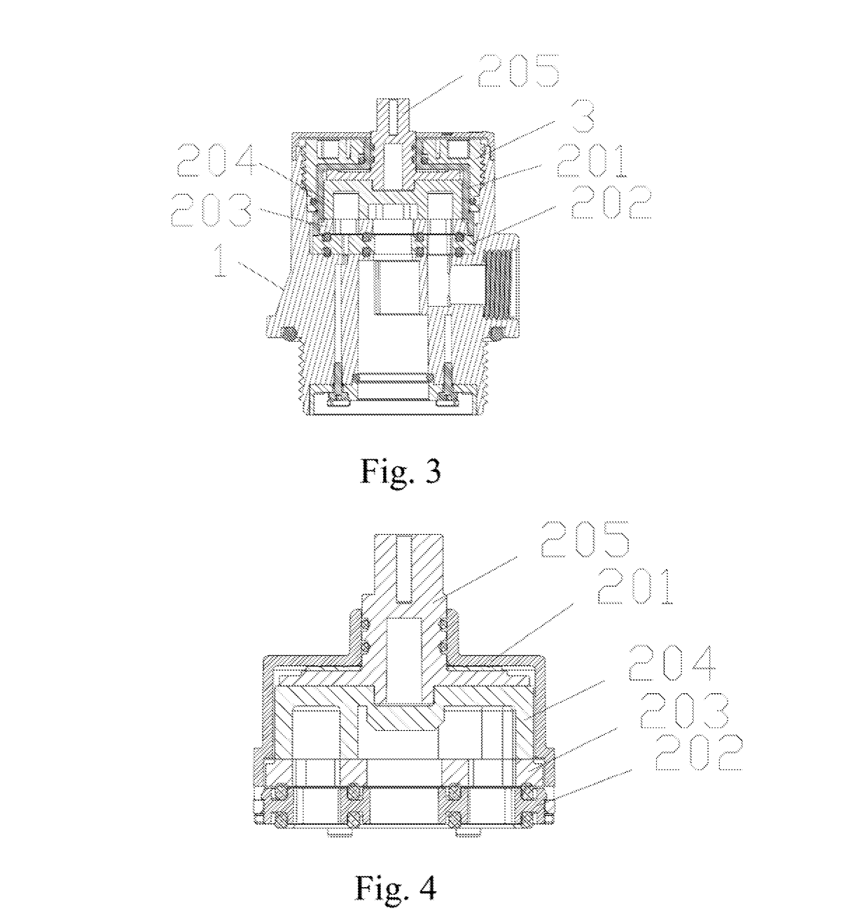

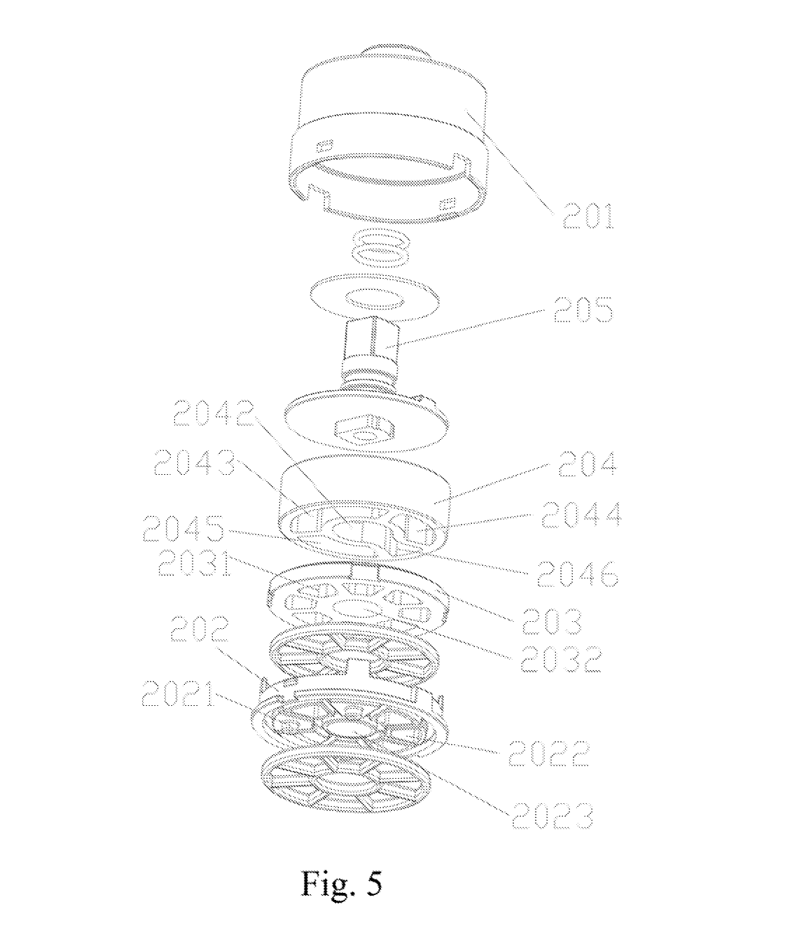

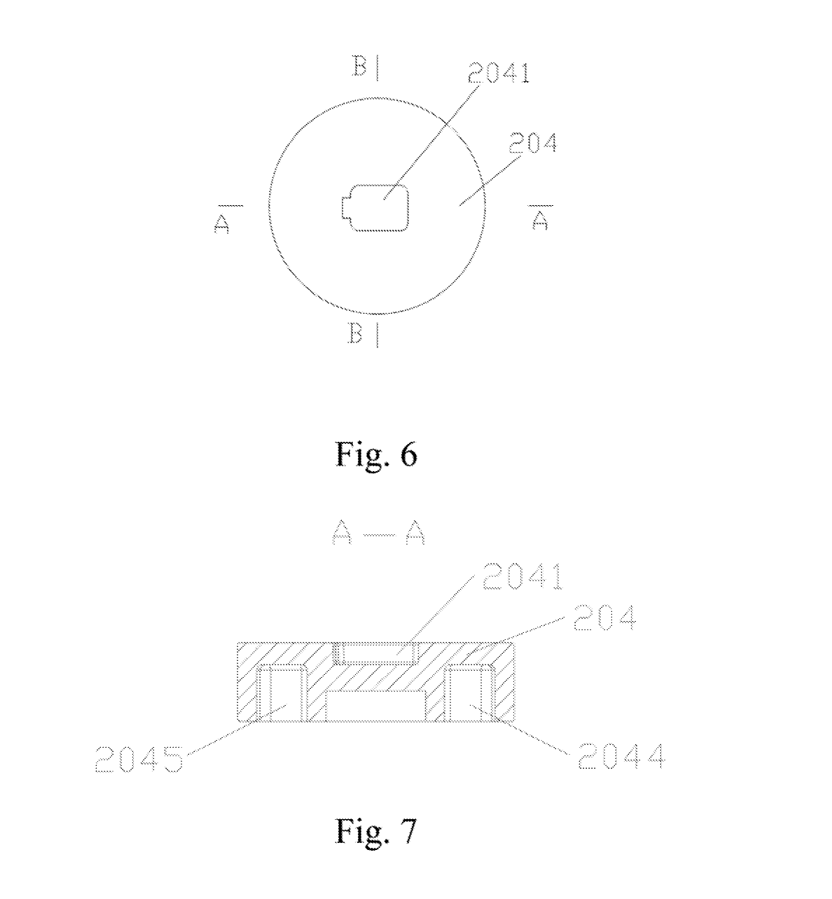

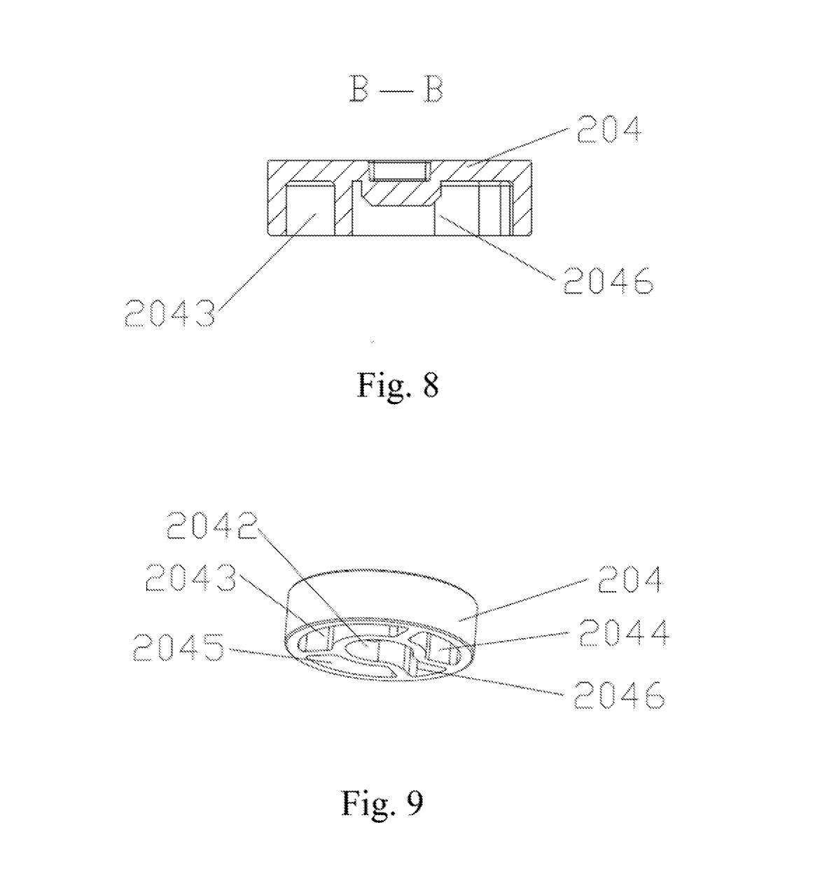

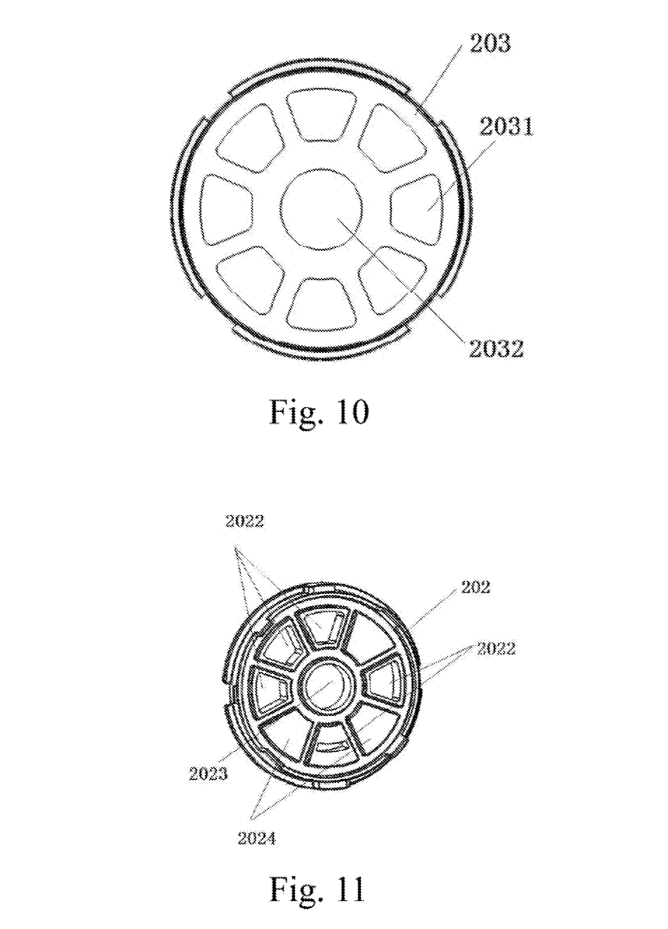

Refer to FIGS. 1 to 14c respectively for a top view of a central water purifier control valve according to an embodiment of the invention; an exploded view of a central water purifier control valve according to an embodiment of the invention; a cross section view of a central water purifier control valve according to an embodiment of the invention; a cross section view of a valve core component according to an embodiment of the invention; an exploded view of a valve core component according to an embodiment of the invention; a top view of a movable ceramic plate according to an embodiment of the invention; a cross section view along the A-A line of FIG. 6 according to an embodiment of the invention; a cross section view along the B-B line of FIG. 6 according to an embodiment of the invention; a schematic diagram of a movable ceramic plate according to an embodiment of the invention; a top view of a fix ceramic plate according to an embodiment of the invention; a schematic diagram of a valve core bottom seat plate according to an embodiment of the invention; schematic diagrams showing water purifying routes according to an embodiment of the invention; schematic diagrams showing filter core forward flushing water routes according to an embodiment of the invention; and schematic diagrams showing filter core reverse flushing water routes according to an embodiment of the invention.

As shown in FIGS. 1 to 14c, the present invention provides a central water purifier control valve, comprising: a valve body 1, a valve core component 2, and a lock tight cover 3. The valve core component 2 is disposed vertically in the valve body 1, including; a cover shape valve core sleeve 201, having a lower opening; a valve core bottom seat plate 202, fixed at the lower opening of the cover shape valve core sleeve 201; a fix ceramic plate 203, disposed between an inner wall of the cover shape valve core sleeve 201 and the valve core bottom seat plate 202; a movable ceramic plate 204, disposed between an inner wall of the cover shape valve core sleeve 201 and the valve core bottom seat plate 202; and a rotation axis 205, disposed between an inner wall of the cover shape valve core sleeve 201 and the valve core bottom seat plate 202, used to drive the movable ceramic plate 204 into rotation, while penetrating through the cover shape valve core sleeve 201. The lock tight cover 3 is used to press the valve core component tightly in the valve body 1, to press it onto the cover shape valve core sleeve 201.

In an embodiment of the present invention, in order to optimize design to realize water control, the central water purifier control valve further includes: a slot 2041, disposed on an upper surface of the movable ceramic plate 204, used to position a lower end head of the rotation axis 205; a first center sink hole 2042, disposed at a center portion of a lower surface of the movable ceramic plate 204; a first sink hole 2043, a second sink hole 2044, and a third sink hole 2045, disposed not in communication with each other, and disposed around the first center sink hole 2042, on a lower surface of the movable ceramic plate 204; a separation indent hole slot 2046, disposed between the second sink hole 2044 and the third sink hole 2045, and in communication with the first center sink hole 2042; and eight through holes 2031, disposed on the fix ceramic plate 203, with equal spacing to each other, such that when the fix ceramic plate 203 is attached to the movable ceramic plate 204, the first sink hole 2043 covers a cross section area of the three through holes 2031, and the second sink hole 2044 and the third sink hole 2045 cover the cross section areas of the other two through holes 2031 respectively, while the separation indent hole slot 2046 covers the cross section area of the through hole 2031.

In an embodiment of the present invention, in order to optimize design to achieve water control, the central water purifier control valve further includes: five through hole positions 2022 are disposed on the valve core bottom seat plate 202, corresponding to five of eight through holes 2031 on the fix ceramic plate 203, wherein three of the five through hole positions 2022 are blind hole positions 2024, while the three blind hole positions 2024 are spaced apart by two of the five through hole positions 2022. A first center hole 2023 and a second center hole 2032 are disposed respectively in a central portion of the valve core bottom seat plate 202 and the fix ceramic plate 203.

In an embodiment of the present invention, the central water purifier control valve further includes: a water input port 101, a water output port 102, and a waste water port 103, disposed at a middle section of the valve body 1, and are connected to a filter core at a bottom portion of the valve body 1; a water input channel 104, disposed at a lower portion of the valve core bottom seat plate 202, and in communication with the water input port 101; a water output channel 105, disposed at the lower portion of the valve core bottom seat plate 202, and in communication with the water output port 102; a waste water channel 106, disposed at the lower portion of the valve core bottom seat plate 202, and in communication with the waste water port 103; a central channel 107, disposed at the lower portion of the valve core bottom seat plate 202, and in communication with a filter core water output port on an upper portion of the filter core; and two water passage channels 108, disposed at the lower portion of the valve core bottom seat plate 202, and in communication with a filter core water input port on the lower portion of the filter core.

In an embodiment of the present invention, the central water purifier control valve further includes: three positioning slots 109, disposed beside the water input channel 104 and the water output channel 105, to act in cooperation with three positioning pins at a lower surface of the valve core bottom seat plate 202.

In an embodiment of the present invention, the water input channel 104, the water output channel 105, the waste water channel 106, the two water passage channels 108, and the three positioning slots 109 correspond to the eight through hole positions 2022 on the valve core bottom seat plate 202.

The water routes for the central water purifier control valve are described as follows.

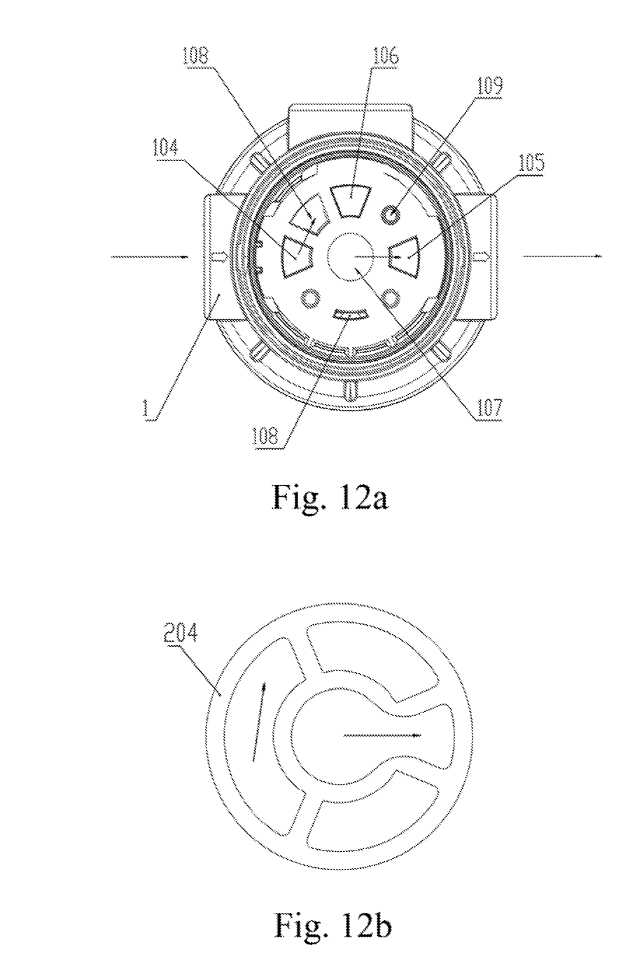

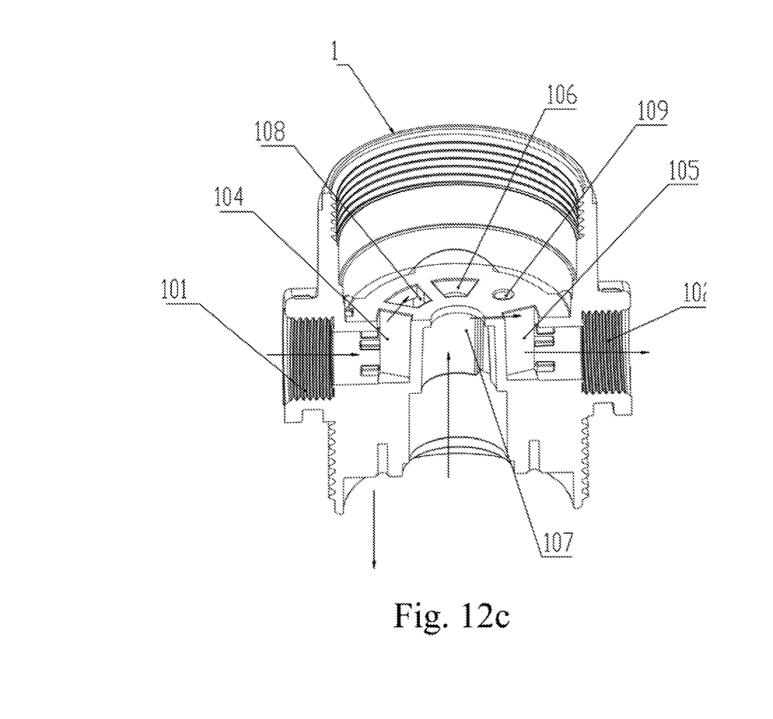

1. Water Purifying Process (FIGS. 12a, 12b, 12c)

Rotating the rotation axis 205, so that the separation indent hole slot 2046 of the movable ceramic plate 204 is moved to right over the water output channel 105 of the valve body 1. As such, water flows in from the water input port 101 of valve body 1, and then it flows through the water input channel 104, the through hole position 2022, and through hole 2031 of the fix ceramic plate 203, to the first sinking hole 2043 of the movable ceramic plate 204. Then, through another set of through hole 2031 and the through hole position 2022 of the fix ceramic plate 203, water flows in the water passage channel 108. Subsequently, the water enters into the filter core through the filter core water input port located at the lower portion of the filter core, then it enters the central channel 107 through the filter core water output port located at the upper portion of the filter core, Then, the water flows through hole 2031 of the fix ceramic plate 203, the first central sinking hole 2042 of the movable ceramic plate 204, and the separation indent hole slot 2046, to reach the water output channel 105. And finally, the water is output from the water output port 102 of the valve body 1, to complete the water purifying process.

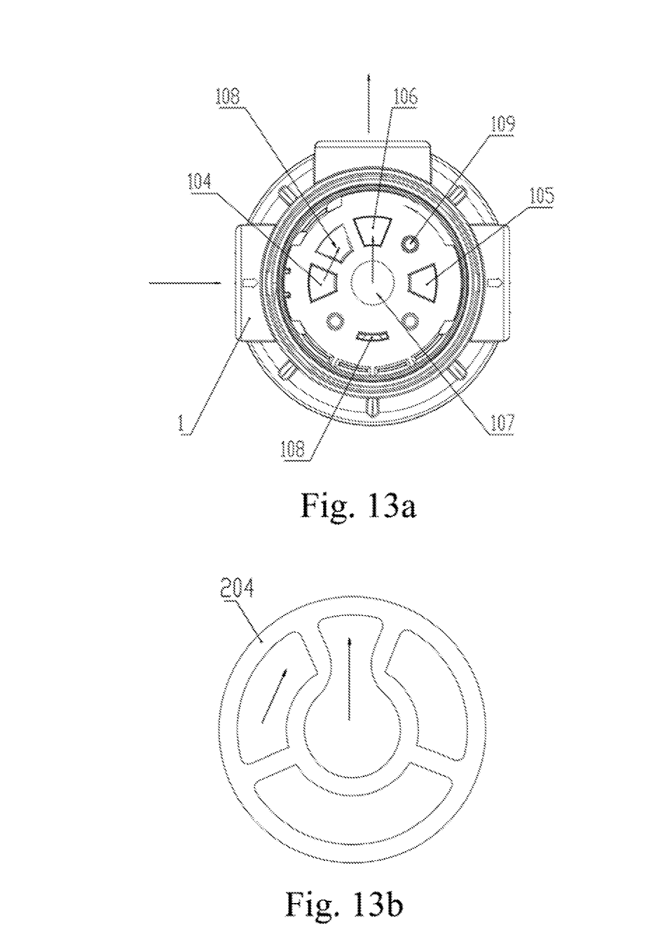

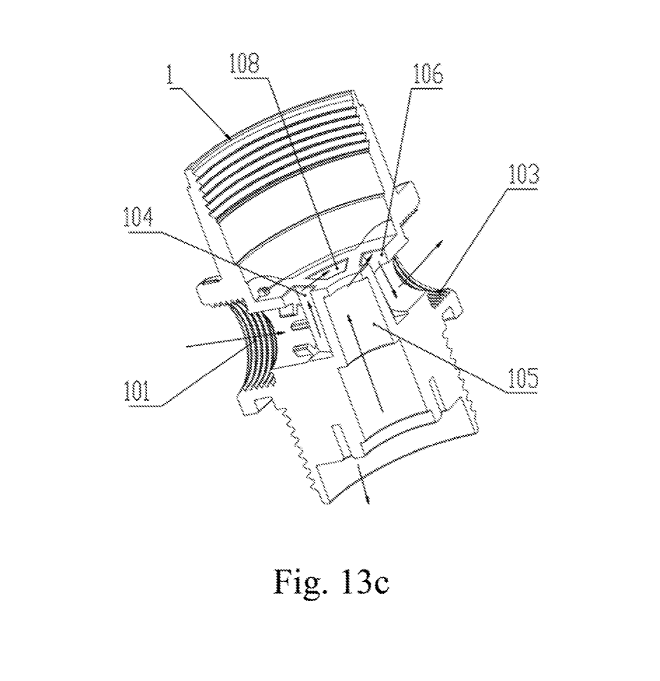

2. Filter Core Forward Flushing Process (FIGS. 13a, 13b, 13c)

Rotating the rotation axis 205, so that the separation indent hole slot 2046 of the movable ceramic plate 204 is moved to right over the waste water channel 106 of the valve body 1. As such, water flows in from the water input port 101 of valve body 1, and then it flows through the water input channel 104, the through hole 2031 of the fix ceramic plate 203, to the first sinking hole 2043 of the movable ceramic plate 204. Then, the water enters into the water passage channel 108, and it flows into the filter core from the filter core water input port located at the lower portion of the filter core. Subsequently, water enters the central channel 107 from the filter core water output port located at the upper portion of the filter core. Then, water flows through the through hole 2031 of the fix ceramic plate 203, the first central sinking hole 2042 of the movable ceramic plate 204, and the separation indent hole slot 2046, to reach the waste water channel 106. And finally, the water is output from the waste water output port 103 of the valve body 1, to complete the filter core forward flushing process.

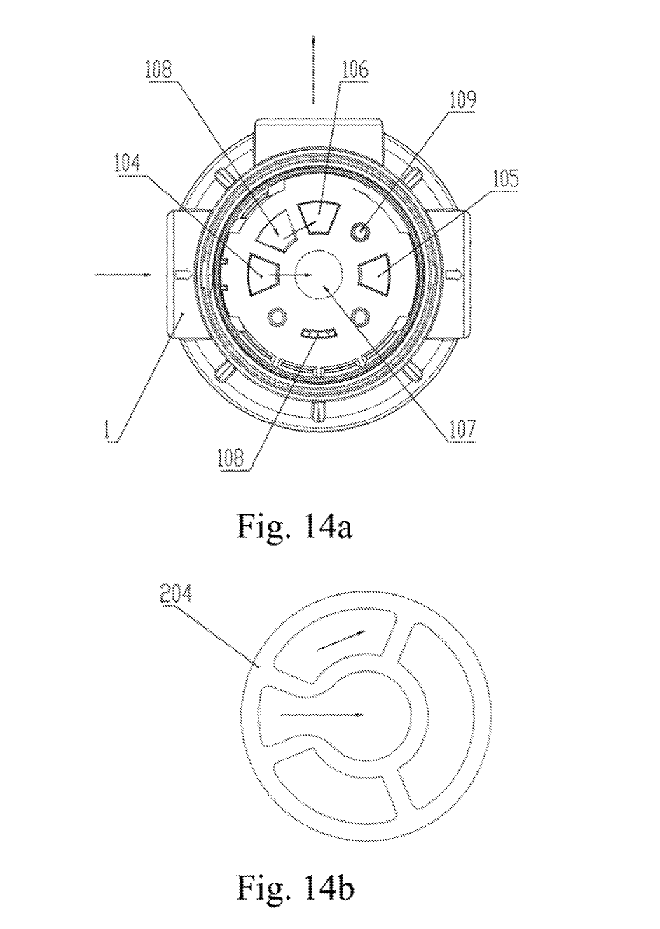

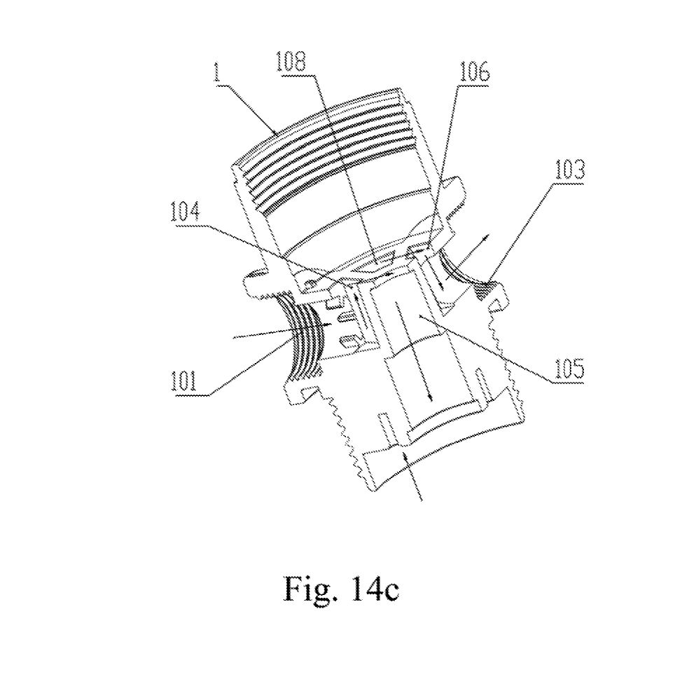

3. Filter Core Reverse Flushing Process (FIGS. 14a, 14b, 14c)

Rotating the rotation axis 205, so that the separation indent hole slot 2046 of the movable ceramic plate 204 is moved to right over the water input channel 104 of the valve body 1. As such, water flows in from the water input port 101 of valve body 1, and then it flows through the water input channel 104, the separation indent hole slot 2046 of the movable ceramic plate 204, and the first central sinking hole 2042, to the central channel 107. Then, the water flows into the filter core through the filter core water output port located at the upper portion of the filter core, and it is output from the filter core water input port located at the lower portion of the filter core. Subsequently, the water flows through the water passage channel 108, the third sinking hole 2045, to reach the waste water channel 106 of the valve body 106. And finally, water is output from the waste water port 103 of the valve body 1, to complete the filter core reverse flushing process.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is::

1. A central water purifier control valve, comprising:
a valve body;
a valve core component, disposed vertically in the valve body, including;
a cover shape valve core sleeve, having a lower opening;
a valve core bottom seat plate, fixed at the lower opening of the cover shape valve core sleeve;
a fix ceramic plate, disposed between an inner wall of the cover shape valve core sleeve and the valve core bottom seat plate;
a movable ceramic plate, disposed between the inner wall of the cover shape valve core sleeve and the valve core bottom seat plate;
a rotation axis, disposed between the inner wall of the cover shape valve core sleeve and the valve core bottom seat plate, used to drive the movable ceramic plate into rotation, while penetrating through the cover shape valve core sleeve; and
a lock tight cover, used to press the valve core component tightly in the valve body, to press it onto the cover shape valve core sleeve.

2. The central water purifier control valve as claimed in claim 1, further comprising:
a slot, disposed on an upper surface of the movable ceramic plate, used to position a lower end head of the rotation axis;
a first center sink hole, disposed at a center portion of a lower surface of the movable ceramic plate;
a first sink hole, a second sink hole, and a third sink hole, disposed not in communication with each other, and disposed around the first center sink hole, on a lower surface of the movable ceramic plate;
a separation indent hole slot, disposed between the second sink hole and the third sink hole, and in communication with the first center sink hole; and
eight through holes, disposed on the fix ceramic plate, with equal spacing to each other, such that when the fix ceramic plate is attached to the movable ceramic plate, the first sink hole covers a cross section area of the three through holes, and the second sink hole and the third sink hole cover the cross section areas of the other two through holes respectively, while the separation indent hole slot covers the cross section area of the through hole.

3. The central water purifier control valve as claimed in claim 2, further comprising:
five through hole positions disposed on the valve core bottom seat plate, corresponding to five of eight through holes on the fix ceramic plate, wherein three of the five through hole positions are blind hole positions, while the three blind hole positions are spaced apart by two of the five through hole positions.

4. The central water purifier control valve as claimed in claim 3, further comprising:
a water input port, a water output port, and a waste water port, disposed at a middle section of the valve body, and are connected to a filter core at a bottom portion of the valve body;
a water input channel, disposed at a lower portion of the valve core bottom seat plate, and in communication with the water input port;
a water output channel, disposed at the lower portion of the valve core bottom seat plate, and in communication with the water output port;
a waste water channel, disposed at the lower portion of the valve core bottom seat plate, and in communication with the waste water port;
a central channel, disposed at the lower portion of the valve core bottom seat plate, and in communication with a filter core water output port on an upper portion of the filter core; and
two water passage channels, disposed at the lower portion of the valve core bottom seat plate, and in communication with a filter core water input port on the lower portion of the filter core.

5. The central water purifier control valve as claimed in claim 4, further comprising:
three positioning slots, disposed beside the water input channel and the water output channel, to act in cooperation with three positioning pins at a lower surface of the valve core bottom seat plate.

6. The central water purifier control valve as claimed in claim 5, wherein
the water input channel, the water output channel, the waste water channel, the two water passage channels, and the three positioning slots correspond to the eight through hole positions on the valve core bottom seat plate.
